(19) United States
(12) Patent Application Publication
(10) Pub. No.: US 2010/0231958 A1
(43) Pub. Date: Sep. 16, 2010

(54) Information processing system, information processing device, communication device, image forming system and image forming device

(75) Inventor: Masafumi Okigami, Osaka-shi (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka-Shi (JP)

(21) Appl. No.: 12/659,503

(22) Filed: Mar. 11, 2010

(30) Foreign Application Priority Data
Mar. 13, 2009 (JP) 2009-061760

(51) Int. Cl. G06F 3/12; H04B 1/38

(52) U.S. Cl. 358/1.15; 455/557

(57) ABSTRACT

A digital multi-function peripheral constantly transmits a signal for starting. When a mobile phone is located within a predetermined distance from the digital multi-function peripheral and receives the signal for starting, the mobile phone then transmits a reply signal to the digital multi-function peripheral. Then, the digital multi-function peripheral connects with the mobile phone by transmitting its identification data to the mobile phone. Further, the digital multi-function peripheral causes, by transmitting data for instructing execution of an application program associated with transmission and reception by the mobile phone to the mobile phone, the mobile phone to execute the application program.

### CROSS-REFERENCE TO RELATED APPLICATIONS

This nonprovisional application claims priority under 35 U.S.C. §119(a) on Patent Application No. 2009-61760, filed in Japan on Mar. 13, 2009, the entire contents of which are hereby incorporated by reference.

### BACKGROUND

1. Technical Field

The present invention relates to a communication device, an information processing device for communicating with the communication device, an information processing system provided with the communication device and the information processing device, an image forming device, and an image forming system provided with the image forming device.

2. Description of Related Art

Recently, mobile phones equipped with a camera function have spread widely, and one can easily take a digital photograph anywhere at any time. In addition, memories to be mounted on a mobile phones have been increased in their capacities, and the cases where the mobile phones are used as personal memory devices which save data, such as digital images, business documents, are increasing.

Japanese Patent Application Publication No. 2007-267370 (hereinafter, referred to as “Publicly Known Document 1”) discloses a wireless communication method performed between an IC (Integrated Circuit) chip of a contactless ID (Identification) card and a card reader/writer section of an image processing device, when a user brings his/her contactless ID (Identification) card (or a wireless communication device having the contactless ID card inside) close to the card reader/writer section of the image processing device. In this wireless communication method, the IC chip of the contactless ID card receives a weak electric wave. The weak electric wave is always emitted from the card reader/writer section, and includes a terminal ID indicative of an ID of the image processing device. The IC chip of the contactless ID card obtains the terminal ID from the weak electric wave, and transmits a user ID of the contactless ID card to the image processing device by using the terminal ID.

Further, in Japanese Patent Application Publication No. 2003-32176 (hereinafter, referred to as “Publicly Known Document 2”), a communication system configured for communication between a reader/writer of a personal computer and a mobile phone is disclosed. In this communication system, the mobile phone is provided with the contactless IC card for communicating by electromagnetic waves with the reader/writer of the personal computer. By a user bringing the mobile phone close to the personal computer, the electromagnetic waves radiated from the reader/writer are received by the contactless IC card. At this time, the mobile phone notifies the personal computer of a card ID set in the contactless IC card. Based on the notified card ID, the personal computer identifies the mobile phone and specifies the mobile phone as a partner for communication.

### SUMMARY

As a method of printing data such as a digital image and a business document which the user has saved in a memory of his/her mobile phone, there is a method in which the mobile phone transmits by radio data to be printed (hereinafter, referred to as “print data”) to an image forming device, and prints out the print data, and the like.

As the method in which a mobile phone transmits by radio print data to an image forming device and the image forming device prints out the print data, there are methods, such as a method in which a mobile phone and an image forming device communicate by radio in accordance with a Bluetooth® communication protocol, a method in which a mobile phone and an image forming device communicate by radio using a RFID (Radio Frequency IDentification) system, a method in which a mobile phone and a image forming device communicate by infrared rays, etc.

When a plurality of devices communicate by radio in accordance with the Bluetooth communication protocol, the plurality of devices for communicating by radio must be set (authenticated) to a state in which they can communicate by being operated. For example, if the mobile phone and the image forming device both support the Bluetooth communication protocol, and they communicate by radio in accordance with the Bluetooth communication protocol, the mobile phone and the image forming device must identify each other by an operation so-called “pairing (or bonding),” and be set to the state in which they can communicate with each other. Pairing is an operation in which the plurality of devices set (authenticate) each other.

However, in pairing, a complicated and troublesome operation may be required. More specifically, if a user intends to transmit the image data stored in the memory of his/her mobile phone to a predetermined image forming device, and then print out the image data, the user searches, by using the mobile phone, for image forming devices which are located within a range of a sphere drawn with a predetermined radius (for example, 100 m) centering the mobile phone and can communicate by radio with the mobile phone in accordance with the Bluetooth communication protocol. As a result of the search, Bluetooth addresses of the plurality of image forming devices are displayed on a display section of the mobile phone. The user must determine a Bluetooth address of the predetermined image forming device among these Bluetooth addresses, and this determination is therefore very troublesome for the user. Because, even if the user has determined the Bluetooth address correctly, the user must perform further finer operations to establish a state in which the mobile phone and the image forming device can communicate with each other. Further, if the image forming device is an image forming device for rent installed in a convenience store, many new users typically use the image forming device. For this reason, most of Bluetooth devices which the user owns communicate by radio with the image forming device for the first time. Whenever an image forming device is to be used, the Bluetooth device must perform pairing with the image forming device.

If a mobile phone and an image forming device communicate by infrared rays, the user must hold or fix the mobile phone for a predetermined period of time so that an infrared port of the mobile phone and an infrared port of the image forming device oppose to each other while the mobile phone transmitting print data to the image forming device by infrared rays.

Further, if the user communicates with an image forming device by radio using his/her mobile phone in a RFID system, such as Felica® or Edy®, because the transmission speed is slow, the user must hold the mobile phone over the image forming device while the mobile phone is transmitting print data.

As methods of easily performing the communication described above, a wireless communication method and a communication system described in Publicly Known Document 1 and Publicly Known Document 2, respectively, are known. In the wireless communication method and the communication system, a RFID system is used, and when a contactless ID card is brought close to a card reader/writer section (a reader/writer of a personal computer) of an image processing device, a user ID of the contactless ID card (a card ID of the contactless IC card) is automatically transmitted to the image processing device (personal computer).

However, in the wireless communication method and the communication system described in Publicly Known Document 1 and Publicly Known Document 2, respectively, after a wireless communication device (a mobile phone) is set to a state in which it can communicate with an image processing device (personal computer), data communication is performed. In this data communication, user friendliness is not considered.

For example, if both the mobile phone and the image forming device support a Bluetooth communication protocol, and the mobile phone and the image forming device are communicating with each other, the user transmits image data stored in a memory of the mobile phone to the image forming device, and then prints out an image based on the image data. At this time, various cases may be considered. They are a case where the user intends to print out only an image currently displayed on the mobile phone, a case where the user intends to print out several images selected from the images saved in the memory of the mobile phone, etc. If the user prints out only an image currently displayed on the mobile phone, there is a problem that the user must further operate the mobile phone or the image forming device other than he/she transmits the data on the image to the image forming device. On the other hand, if the user selects several images from a plurality of images and then prints out them, there is a problem that the user must select file names (or thumbnails) of the images to be printed from a plurality of file names (or thumbnails) which are displayed small in size on the small display section of the mobile phone. The wireless communication method and the communication system described in Publicly Known Document 1 and Publicly Known Document 2, respectively, are not devised to achieve such user friendliness, and cannot deal with the problems described above.

The present invention is made in view of these situations, and the purpose of the present invention is to provide an information processing system that can easily connect an information processing device with a communication device, and can eliminate user's burden in transmission and reception of data which the information processing device and the communication device perform.

Another purpose of the present invention is to provide an information processing device that can easily connect with a partner for transmission and reception, and can eliminate user's burden in the transmission and reception of data, which is performed with the partner for transmission and reception.

Still another purpose of the present invention is to provide a communication device that can easily connect with a partner for communication, and can appropriately eliminate user's burden in communication with a partner for communication, if needed.

Another purpose of the present invention is to provide an image forming system that can easily connect an image forming device with a portable communication device, and can eliminate user's burden produced when the image forming device obtains data from the portable communication device and then forms an image based on the data.

Another purpose of the present invention is to provide an image forming device that can easily connect with a partner for communication, and can eliminate user's burden produced when it receives data from the partner for communication and then forms an image based on the data.

According to an aspect of the present invention, an information processing system includes a communication device, and an information processing device for obtaining data from the communication device and processing the data. The communication device includes a first transmission and reception section for performing transmission and reception of data to and from the information processing device, a reception section for receiving identification data for identifying the information processing device from the information processing device, and a storage section for storing an application program associated with the transmission and reception of data to and from the information processing device. The information processing device includes a second transmission and reception section for performing transmission and reception of data to and from the first transmission and reception section, a transmission section for transmitting the identification data for identifying the information processing device to the reception section of the communication device, and an instruction transmission section for transmitting instruction data for instructing execution of the application program stored in the storage section to the first transmission and reception section.

In the aspect of the present invention, when the communication device and the information processing device transmit and receive data to and from them, the transmission section of the information processing device transmits identification data for identifying the information processing device to the reception section of the communication device. The first transmission and reception section connects with the second transmission and reception section by using the identification data received by the reception section. Then, the instruction transmission section of the information processing device transmits instruction data to the communication device. Thereby, the information processing device instructs the communication device to execute an application program stored in the storage section.

Because the information processing device transmits its identification data to the communication device, the information processing device and the communication device can easily be connected with each other. Because the communication device has the application program associated with transmission and reception and the information processing device causes the communication device to execute the application program, user's burden can be eliminated in the transmission and reception of the data which the information processing device and the communication device perform.

According to an aspect of the present invention, the storage section stores a plurality of application programs. The communication device further includes a selection accepting section for accepting a selection of an application program to be executed from the plurality of application programs, and an execution section for executing the application program associated with the selection accepted by the selection accepting section when the instruction data is received.

In the aspect of the present invention, the user selects one program from the plurality of application programs. The selection accepting section of the communication device accepts the selection of the program by the user. When the communication device receives the instruction data from the information processing device, the execution section executes the program associated with the selection accepted by the selection accepting section.

According to an aspect of the present invention, the communication device further includes a display section for displaying images associated with the stored contents. The storage section stores a first application program including processing for transmitting listing data indicative of a listing of the stored contents to the information processing device, or a second application program including processing for transmitting data of the contents associated with the images displayed on the display section to the information processing device.

In the aspect of the present invention, the first application program or the second application program is stored in the storage section. The first application program includes the processing for transmitting the listing data to the information processing device. The listing data includes the contents to be displayed as listings. The contents are stored in the storage section. The second application program includes the processing for transmitting the data of the contents associated with the images displayed on the display section to the information processing device.

According to an aspect of the present invention, the communication device transmits data of the contents associated with images displayed on the display section to the second transmission and reception section of the information processing device, when the communication device is located within a predetermined distance from the information processing device in the case where the selection accepting section has accepted the selection of the first application program.

In the aspect of the present invention, in the case where the selection accepting section of the communication device has accepted the selection of the first application program, and when the communication device is located within the predetermined distance from the information processing device, the first transmission and reception section transmits data of the contents associated with images displayed on the display section to the second transmission and reception section of the information processing device.

According to an aspect of the present invention, the information processing device further includes a display section for displaying a list screen based on the received listing data, a content selection accepting section for accepting a selection of a content from the contents displayed on the display section, and a request transmission section for transmitting request data for requesting data of the content accepted by the content selection accepting section to the communication device.

In the aspect of the present invention, when the information processing device receives the listing data, the display section, the content selection accepting section, and the request transmission section perform the following operations. The display section displays the list screen based on the listing data. The user selects one content from the plurality of contents displayed on the display section. The content selection accepting section accepts the user's selection. The request transmission section transmits request data for requesting data of the contents which the content selection accepting section has accepted to the communication device. Thus, the information processing device processes the data of the contents obtained from the communication device.

According to an aspect of the present invention, the transmission section and the reception section communicate by using a RFID system, and the first transmission and reception section and the second transmission and reception section communicate by radio over a longer distance or at a higher speed than with the RFID system.

In the aspect of the present invention, the transmission section and the reception section are a contact or contactless IC card and a card reader, respectively, and communicate with each other by using a RFID system, for example. Both the first transmission and reception section and the second transmission and reception section are devices that support a Bluetooth communication protocol, and communicate by radio over a long distance or at a high speed using the Bluetooth communication protocol.

According to an aspect of the present invention, the communication device stores the identification data received by the reception section in a free area of a storage area within the RFID system.

In the aspect of the present invention, when the reception section of the communication device receives the identification data for identifying the information processing device, the communication device stores the identification data in a free area of a storage area in the RFID system.

According to an aspect of the present invention, an information processing device includes a transmission and reception section for performing transmission and reception of data to and from an external device, a transmission section for transmitting identification data for identifying the transmission and reception section, and an instruction transmission section for transmitting instruction data for instructing execution of an application program associated with transmission and reception of data and stored in a partner for transmission and reception.

In the aspect of the present invention, when the transmission and reception section of the information processing device performs transmission and reception of data to and from an external device, the transmission section and the instruction transmission section perform the following operations. The transmission section transmits identification data for the transmission and reception section to the partner for transmission and reception. The instruction transmission section transmits instruction data to the partner for transmission and reception, and instructs the partner for transmission and reception to execute the application program.

Because the information processing device transmits its identification data to the partner for transmission and reception, the information processing device can easily be connected with the partner for transmission and reception. Because the partner for transmission and reception has the application associated with transmission and reception and the information processing device causes the partner for transmission and reception to execute the application, user's burden can be eliminated in the transmission and reception of the data between the information processing device and the partner for transmission and reception.

According to an aspect of the present invention, the information processing device further includes a display section for displaying, when the transmission and reception section has received listing data indicative of listings of contents stored in the partner for transmission and reception, a list screen based on the listing data, a content selection accepting section for accepting a selection of content from the contents displayed on the display section, and a request transmission section for transmitting request data for requesting data of the content accepted by the content selection accepting section to the partner for transmission and reception.

In the aspect of the present invention, when the transmission and reception section receives listing data, the display section, the content selection accepting section, and the request transmission section perform the following operations. The display section displays the list screen based on the listing data. The user selects one content from the plurality of contents displayed on the display section. The content selection accepting section accepts the selection of the contents by the user. The request transmission section transmits the request data to the partner for transmission and reception. Thereby, the information processing device requests the partner for transmission and reception for data of the content associated with the selection which the content selection accepting section has accepted. Thus, the information processing device processes the data of the content obtained from the partner for transmission and reception.

According to an aspect of the present invention, a communication device includes a communication section for communicating, a reception section for receiving identification data for identifying a partner for communication from the partner for communication, a storage section for storing a plurality of application programs associated with communication with the partner for communication, a selection accepting section for accepting a selection of the application program to be executed from the plurality of application programs, and an execution section for executing the program associated with the selection accepted by the selection accepting section when predetermined data is received.

In the aspect of the present invention, when the communication section communicates with a partner for communication, the reception section receives the identification data which the partner for communication has, and connects with the partner for communication using the identification data. The user selects one program from the plurality of application programs. The selection accepting section accepts the selection of the application program by the user. The execution section executes the program associated with the selection accepted by the selection accepting section, when the communication device has received the predetermined data for communication, for example.

Because the reception section of the communication section receives the identification data for identifying the partner for communication, the communication device can easily be connected with the partner for communication using the identification data. When the predetermined data (for example, the data from the partner for communication) is received, because the partner for communication is caused to execute the program associated with the communication which the selection accepting section has accepted the selection there of, user's burden can be eliminated appropriately, if needed, in the communication with the partner for communication.

According to an aspect of the present invention, the communication device includes a display section for displaying images associated with contents stored. The storage section stores a first application program including processing for transmitting listing data for displaying the stored contents by listings, or a second application program including processing for transmitting data of the contents associated with the images displayed on the display section.

In the aspect of the present invention, a first application program or a second application program is stored in the storage section. The first application program includes processing for transmitting listing data. The listing data includes contents to be displayed as listings. The contents are stored in the storage section. The second application program includes processing for transmitting data of the content associated with the image displayed on the display section.

According to an aspect of the present invention, an image forming system includes a portable communication device, and an image forming device for obtaining data from the portable communication device and forming an image based on the data. The portable communication device includes a first transmission and reception section for performing transmission and reception of data to and from the image forming device, a reception section for receiving identification data for identifying the image forming device from the image forming device, and a storage section for storing an application program associated with transmission and reception of data to and from the image forming device. The image forming device includes a second transmission and reception section for performing transmission and reception of data to and from the first transmission and reception section, a transmission section for transmitting identification data for identifying the image forming device to the reception section, and an instruction transmission section for transmitting instruction data for instructing execution of the application program stored in the storage section.

In the aspect of the present invention, when the portable communication device and the image forming device transmit and receive data, the transmission section of the image forming device and the first transmission and reception section perform the following operations. The transmission section of the image forming device transmits the identification data for the image forming device to the reception section of the portable communication device. The first transmission and reception section connects with the second transmission and reception section by using the identification data received by the reception section. Then, the instruction transmission section of the image forming device transmits the instruction data to the portable communication device, and instructs the portable communication device to execute the application program stored in the storage section.

Because the image forming device transmits its identification data to the portable communication device, the image forming device and the portable communication device can easily be connected with each other. Because the portable communication device has an application program associated with transmission and reception and the image forming device causes the portable communication device to execute the application program, when the image forming device obtains the data from the portable communication device and forms the image based on the data, user's burden can be eliminated.

According to an aspect of the present invention, the image forming device further includes a notifying section for notifying the portable communication device of an abnormality occurrence or a normal termination in formation of an image.

In the aspect of the present invention, in the case where an abnormality occurs when an image is formed, or in the case where formation of an image is completed normally, the notifying section of the image forming device notifies the portable communication device of that.

According to an aspect of the present invention, an image forming system includes a portable communication device, and an image forming device for obtaining data from the portable communication device and forming an image based on the data. The portable communication device includes a first data communication section for performing communication of data with the image forming device by using a Bluetooth communication protocol, a reception section for receiving a unique address of the image forming device from the image forming device by using a RFID communication protocol, a storage section for storing a plurality of application programs associated with communication of data with the image forming device, and a selection accepting section for accepting a selection of the application program to be executed from the plurality of application programs. The image forming device includes a second data communication section for performing communication of data with the first data communication section by using the Bluetooth communication protocol, a transmission section for transmitting the unique address of the image forming device to the reception section by using the RFID communication protocol, and an instruction transmission section for transmitting instruction data for instructing execution of the application program stored in the storage section. The portable communication device executes the program associated with the selection accepted by the selection accepting section when the instruction data is received.

In the aspect of the present invention, when the portable communication device and the image forming device transmit and receive data, the transmission section of the image forming device and the reception section of the portable communication device perform the following operations. The transmission section of the image forming device transmits the unique address of the image forming device to the reception section of the portable communication device using the RFID communication protocol. The reception section of the portable communication device receives the unique address of the image forming device. The first data communication section connects with the second data communication section of the image forming device by using the unique address. The selection accepting section of the portable communication device accepts the selection of the application program to be executed from the plurality of application programs. The portable communication device executes the program associated with the selection accepted by the selection accepting section, when instruction data is received from the instruction transmission section of the image forming device.

According to an aspect of the present invention, an image forming device includes a communication section for performing communication of data by using a Bluetooth communication protocol, a transmission section for transmitting a unique address of the communication section by using a RFID communication protocol, an instruction transmission section for transmitting instruction data for instructing execution of an application program associated with the communication of the data and stored in a partner for communication, and a display section. An image based on the data received by execution of the application program is formed on the display section or a sheet.

In the aspect of the present invention, when performing communication of the data with the partner for communication, the transmission section transmits a unique address of the communication section to the partner for communication using a RFID communication protocol, and connects with the partner for communication. The instruction transmission section transmits instruction data to the partner for communication, and causes the partner for communication to execute the application program which the partner for communication has. Thereby, the image forming device forms an image based on the received data on the display section or the sheet.

Because the image forming device transmits its identification data to the portable communication device, the image forming device and the portable communication device can easily be connected with each other. Because the partner for communication has an application program associated with communication of data and the image forming device causes the partner for communication to execute the application program, when the image forming device receives data from the partner for communication and forms an image based on the data, user's burden can be eliminated.

The above and further objects and features will more fully be apparent from the following detailed description with accompanying drawings.

### BRIEF DESCRIPTION OF THE SEVERAL VIEWS OF THE DRAWINGS

FIG. 1 is a conceptual diagram of an information processing system and an image forming system according to Embodiment 1;

FIG. 2 is a block diagram showing a configuration of an essential construction of the information processing system and the image forming system according to Embodiment 1;

FIG. 3A is a flowchart showing procedures executed by a CPU (Central Processing Unit) of a control section of a digital multi-function peripheral and a CPU of a control section of a mobile phone according to Embodiment 1;

FIG. 3B is a flowchart showing procedures executed by the CPU of the control section of the digital multi-function peripheral and the CPU of the control section of the mobile phone according to Embodiment 1;

FIG. 4 is an illustrated view showing an example of an application selection screen for selecting an application associated with transmission of image data;

FIG. 5 is a diagram illustrating a configuration of a storage area of a contact/contactless IC card according to Embodiment 1;

FIG. 6 is an illustrated view showing an example of a list screen displayed on a display section of the digital multi-function peripheral according to Embodiment 1;

FIG. 7 is a flowchart showing procedures executed by a CPU of a control section of the digital multi-function peripheral and a CPU of a control section of a mobile phone according to Embodiment 2; and

FIG. 8 is a diagram illustrating an operation for selecting an image which a user intends to print out, and an operation for displaying the image which the user has selected on a display section, in the mobile phone according to Embodiment 2;

### DETAILED DESCRIPTION

Hereinafter, an information processing system and an image forming system according to the present invention are specifically described using the drawings. The information processing device and the image forming device each serves as a digital multi-function peripheral that has a copy function, a print function, etc., and a communication device serves herein as a mobile phone.

### Embodiment 1

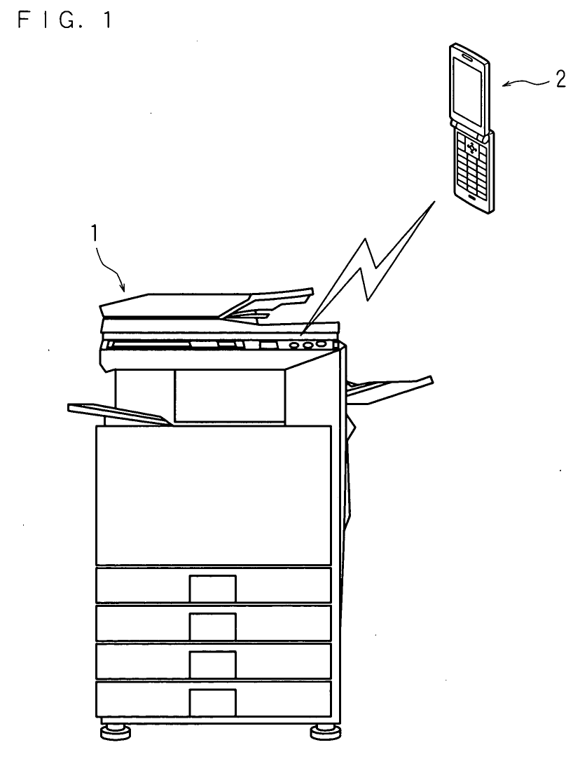

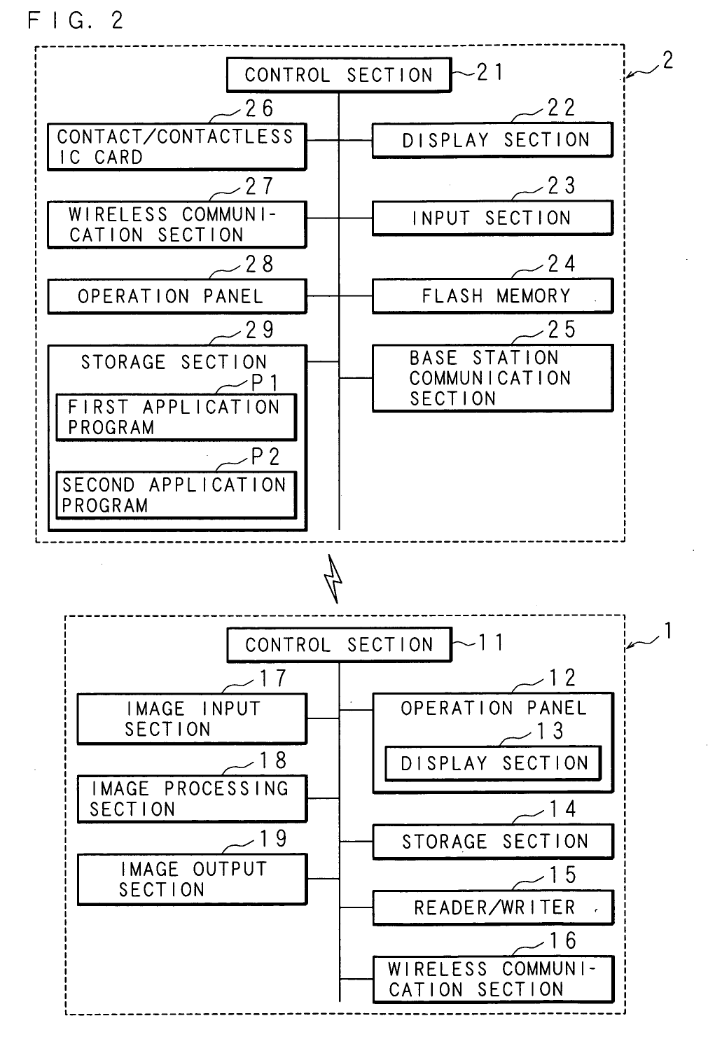

FIG. 1 is a conceptual diagram of the information processing system and the image forming system according to Embodiment 1 of the present invention. FIG. 2 is a block diagram showing a configuration of an essential construction of the information processing system and the image forming system according to Embodiment 1. The information processing system and the image forming system according to Embodiment 1 have a digital multi-function peripheral 1 and a mobile phone 2.

The digital multi-function peripheral 1 includes hardware, such as a control section 11, an image input section 17, an image processing section 18, an image output section 19, a storage section 14, a wireless communication section 16, a reader/writer 15, and an operation panel 12.

The control section 11 includes a CPU and a RAM (Random Access Memory). The CPU controls the hardware described above, and the RAM temporarily stores data required when controlling the hardware. The storage section 14 is a nonvolatile semiconductor memory, etc. The storage section 14 stores image data for image processing, control programs for controlling the hardware described above, programs for displaying a list screen, and image data received via the wireless communication section 16. The programs for displaying the list screen will be described later. A plurality of passkeys are stored in the storage section 14 in advance. When a user operates operation panels 28 or 12, and the CPU of the control section 11 then accepts passkeys from the operation panels 28 or 12, the CPU of the control section 11 compares the accepted passkeys with the passkeys stored in the storage section 14.

The control section 11 loads the control program from the storage section 14 if needed, and then executes the loaded control program. Thereby, the control section 11 operates the digital multi-function peripheral 1 as the image forming device according to the present invention.

The operation panel 12 includes various buttons for accepting instructions from the user, an enter key for accepting confirmation of instructions, a ten-key keypad, etc. Further, the operation panel 12 is provided with a display section 13, such as a liquid crystal display, and displays listings of images, documents, files (contents data) which the mobile phone 2 has, etc. The display section 13 functions as a touch panel display.

The image input section 17 has a reading section for optically reading an image of a document, and a light source that irradiates light to the document to be read. As an example of the light source, an image sensor called “CCDs (Charge Coupled Devices)” is typically used. When a document is set to a predetermined reading position, in the image input section 17, an optical image drawn by the light reflected on the document is formed on the image sensor, and analog electric signals representing RGB (R: Red, G: Green, B: Blue) are outputted. The analog electric signals outputted by the image input section 17 are inputted into the image processing section 18.

The image output section 19 forms an image on a sheet based on the image data outputted from the image processing section 18. The sheet may be a sheet of paper, an OHP sheet, etc. Thus, the image output section 19 includes a photoconductor drum, an electrostatic charger, a laser writing device, a development device, a transferring device, etc. (not shown) to form on the sheet an image which the user wants by using an electrophotographic method. The electrostatic charger charges the photoconductor drum to a predetermined electrical potential. The laser writing device accepts an image data from an exterior device, and then outputs laser beams corresponding to the image data to generate an image of static electricity on the photoconductor drum. The development device develops the image of static electricity by supplying toner to the image of static electricity formed on the surface of the photoconductor drum. The transferring device transfers the image of toner formed on the surface of the photoconductor drum on the sheet. Note that, as methods of forming an image, there are an inkjet method, a heat transfer method, a sublimation method besides the electrophotographic method using the laser writing device, and the image may be formed using any of these methods.

The image processing section 18 converts the analog electric signal outputted from the image input section 17 into digital image data. Then, the image processing section 18 applies processing corresponding to the type of the image to generate image data for output. The generated image data is outputted to the image output section 19 or the wireless communication section 16.

The wireless communication section 16 is a device that supports a Bluetooth communication protocol, for example. The wireless communication section 16 is located within a predetermined short distance (for example, 100 m), and connects by radio with another device supporting the Bluetooth communication protocol (for example, a wireless communication section 27 described later). More specifically, a device supporting the Bluetooth communication protocol has a unique Bluetooth address (identification data). The device supporting the Bluetooth communication protocol performs processing which is so-called “pairing (authenticated)” to specify a partner with which it connects through a network called “the Piconet,” to connect by radio with another device supporting to the Bluetooth communication protocol. The Piconet is a network which will be established dynamically and automatically for one device supporting the Bluetooth communication protocol, when another device supporting the Bluetooth communication protocol comes within a predetermined distance range, and disappear dynamically and automatically when said other device goes out of the predetermined distance range. The wireless communication section 16 is not necessarily a device supporting the Bluetooth communication protocol. For example, the wireless communication section 16 may be a device supporting IEEE 802.11. However, in this case, the device to be connected with the wireless communication section 16 by radio (for example, the wireless communication section 27 described later) must also be a device supporting IEEE 802.11.

The reader/writer 15 transmits and receives data in a RFID system in a state in which it is in contact with or contactless with a contact/contactless IC card 26 described later. In the RFID system, a communication method in which a device which constitutes the system can communicate also in the contactless state is adopted. Hereinafter, communication to be established in the contactless state of the reader/writer 15 and the contact/contactless IC card 26 will be explained. The reader/writer 15 constantly transmits a signal (electromagnetic wave) for starting. When the contact/contactless IC card 26 and the reader/writer 15 approach each other within a distance where they can communicate with each other, the contact/contactless IC card 26 receives the electromagnetic wave transmitted from the reader/writer 15. When the contact/contactless IC card 26 receives the electromagnetic wave, the contact/contactless IC card 26 generates direct current power by rectifying a carrier wave of the electromagnetic wave, and drives an internal circuit with the direct current power. The contact/contactless IC card 26 generates a reply signal by amplitude modulation, and transmits the reply signal corresponding to the signal for starting to the reader/writer 15. As an example of the communication system which the reader/writer 15 and the contact/contactless IC card 26 constitute, there are an RFID system, such as Felica® and Edy®. The reader/writer 15 transmits the unique Bluetooth address (identification data) which the wireless communication section 16 has to the contact/contactless IC card 26.

In order to allow a plurality of devices that support the Bluetooth communication protocol to perform pairing to connect with each other, the user generally needs to perform the following operations. The user searches for another device which is located within a predetermined range from the user's device and supports the Bluetooth communication. The user must specify an address which the user's desired device (the digital multi-function peripheral 1) has from among a plurality of addresses which a plurality of devices retrieved by the search have respectively. However, such a troublesome operations are eliminated in the information processing system and the image forming system according to the present invention.

The mobile phone 2 includes a control section 21 which has a CPU, programs, a ROM (Read-Only Memory), a RAM, etc., and a flash memory 24. The CPU controls hardware which constitutes the mobile phone 2. The ROM records various data, etc. The RAM writes in or reads out data at a high speed. The flash memory 24 has a large capacity and stores telephone numbers, image data, etc. In addition, the flash memory 24 stores image data, such as listing data, images, and thumbnails. The listing data is data for displaying listings of images, documents, files (contents data), etc. which the mobile phone 2 has.

Further, the mobile phone 2 includes a base station communication section 25, an operation panel 28, an input section 23, and a display section 22. The base station communication section 25 has a communication interface and communicates with a base station. The operation panel 28 consists of push buttons for accepting operations by the user. The input section 23 performs acquisition of an image captured by a camera, acceptance of sound inputted into a microphone, etc. The display section 22 performs output of an image by an LCD monitor, etc.

Further, the mobile phone 2 is provided with a storage section 29 for storing various application programs. The storage section 29 stores a first application program P1 and a second application program P2 associated with transmission of data. A transmission method of the data may vary according to application of the first application program P1 or the second application program P2. The first application program P1 responds to predetermined data transmitted from an external device (for example, the digital multi-function peripheral 1), and transmits listing data stored in the flash memory 24. The second application program P2 responds to predetermined data transmitted from an external device, and transmits image data of the image displayed on the display section 22.

The storage section 29 stores a program for displaying an application selection screen described later on the display section 22. The CPU of the mobile phone 2 displays the application selection screen on the display section 22. The first application program P1 or the second application program P2 is selected by the user in the application selection screen. Thereby, the CPU of the mobile phone 2 can receive the user's selection.

The mobile phone 2 includes a contact/contactless IC card 26, and a wireless communication section 27. The contact/contactless IC card 26 transmits and receives data in a contact or contactless state with the reader/writer 15 by using a communication method in which a plurality of devices can communicate with each other also in the contactless state. As an example of the communication system using this communication method, an RFID system, such as Felica® or Edy® may be adopted. The wireless communication section 27 is a device supporting a Bluetooth communication protocol, for example. When another device supporting the Bluetooth communication protocol (for example, the wireless communication section 16) is located within a predetermined distance (for example, 100 m) from the wireless communication section 27, the wireless communication section 27 connects and communicates with that device by radio.

The mobile phone 2 can select a transmission method of data when the user transmits the data stored in the mobile phone 2. That is, the user selects the first application program P1 or the second application program P2 by operating the operation panel 28. The first application program P1 and the second application program P2 are stored in the storage section 29. The mobile phone 2 selects the transmission method of data by the user's selection. When the user selects the first application program P1, the listing data associated with file names of images and documents, etc. stored in the flash memory 24 is transmitted to the partner for communication. When the user selects an image from the listing data in the partner for communication, image data of the selected image is transmitted from the mobile phone 2 to the partner for communication. On the other hand, when the user selects the second application program P2, data associated with the image displayed on the display section 22 of the mobile phone 2 is transmitted to the partner for communication.

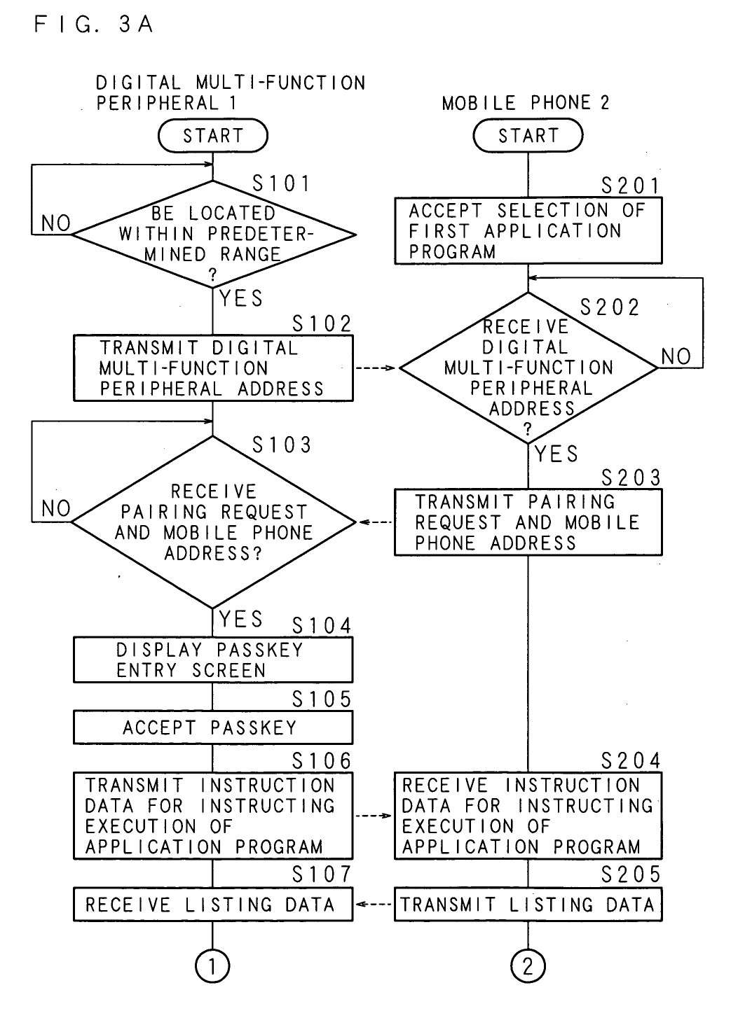

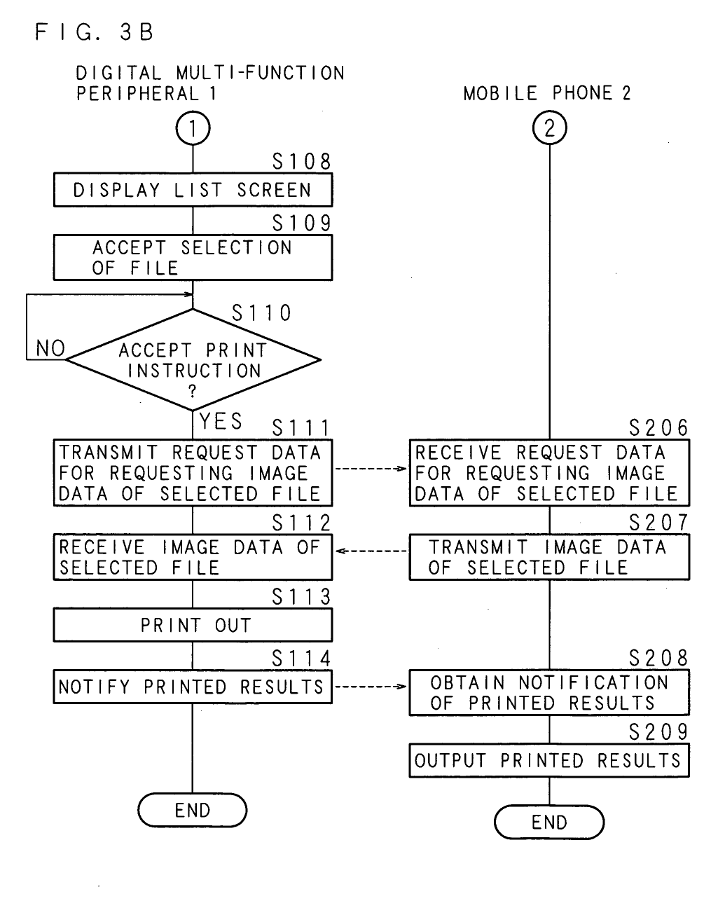

Hereinafter, the information processing system, the information processing device and the communication device and the image forming system and the image forming device, according to Embodiment 1, are described. As an example of the processing which they perform, processing which the digital multi-function peripheral 1 and the mobile phone 2 perform (information processing, image formation) is described. As an example of the processing which the digital multi-function peripheral 1 and the mobile phone 2 perform (the information processing and the image formation), Embodiment 1 is described about the case where the mobile phone 2 transmits image data stored in the mobile phone 2 to the digital multi-function peripheral 1 and the digital multi-function peripheral 1 then prints out an image on a sheet. FIG. 3A and FIG. 3B are a flowchart showing procedures executed by the CPU of the control section 11 of the digital multi-function peripheral 1 and the CPU of the control section 21 of the mobile phone 2, according to Embodiment 1. Note that, in the information processing system and the image forming system according to Embodiment 1, both the digital multi-function peripheral 1 and the mobile phone 2 are devices that support a Bluetooth communication protocol.

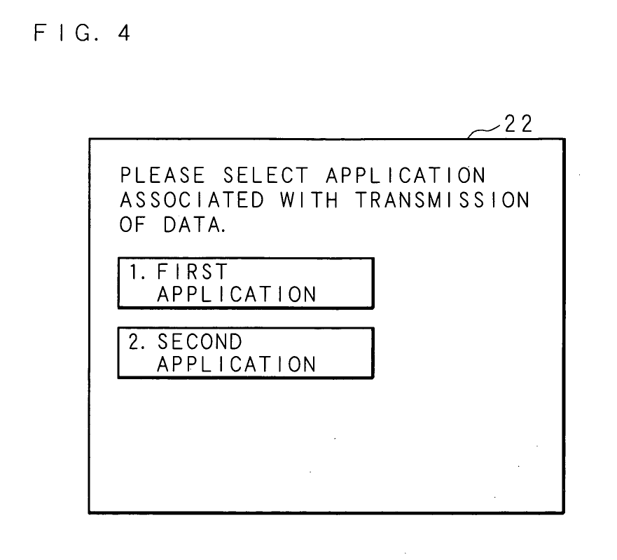

Before the user transmits image data to the digital multi-function peripheral 1 from the mobile phone 2, he/she operates the operation panel 28 of the mobile phone 2 and to select an application associated with the image data. Hereinafter, the case where the user selects the first application program P1 is described for the sake of convenience of explanation. FIG. 4 is an illustrated view showing an example of the application selection screen for selecting an application associated with transmission of image data. In the application selection screen, items of “1. FIRST APPLICATION” and “2. SECOND APPLICATION” are displayed as choices. The user can select one item by appropriately operating the operation panel 28.

The user selects the first application by operating the operation panel 28 and, thus, the first application program P1 is selected. The CPU of the mobile phone 2 then accepts the selection of the first application program P1 via the operation panel 28 (Step S201).

The CPU of the digital multi-function peripheral 1 determines whether the mobile phone 2 is located within a predetermined range (Step S101). The reader/writer 15 included in the digital multi-function peripheral 1 constantly transmits the signal (electromagnetic wave) for starting. When the user holds the mobile phone 2 over the reader/writer 15 of the digital multi-function peripheral 1, a reply signal corresponding to the signal for starting is transmitted to the reader/writer 15 by the technique described above from the contact/contactless IC card 26 of the mobile phone 2. When the reply signal is received, the CPU of the digital multi-function peripheral 1 determines that the mobile phone 2 is located within the predetermined range.

If it determines that the mobile phone 2 is not located within the predetermined range (Step S101: NO), the CPU of the digital multi-function peripheral 1 stands by until the mobile phone 2 is located within the predetermined range. If it determines that the mobile phone 2 is located within the predetermined range (Step S101: YES), the CPU of the digital multi-function peripheral 1 then reads the Bluetooth address which the wireless communication section 16 has (hereinafter, referred to as a “digital multi-function peripheral address”), and then transmits the digital multi-function peripheral address to the reader/writer 15. The reader/writer 15 then transmits the digital multi-function peripheral address (identification data) to the contact/contactless IC card 26 of the mobile phone 2 (Step S102).

The CPU of the mobile phone 2 determines whether the contact/contactless IC card 26 has received the digital multi-function peripheral address by monitoring the contact/contactless IC card 26 (Step S202). If it determines that the contact/contactless IC card 26 has not received the digital multi-function peripheral address (Step S202: NO), the CPU of the mobile phone 2 stands by until the contact/contactless IC card 26 receives the digital multi-function peripheral address. If it determines that the contact/contactless IC card 26 has received the digital multi-function peripheral address (Step S202: YES), the CPU of the mobile phone 2 stores the digital multi-function peripheral address which the contact/contactless IC card 26 has received in a storage area of the contact/contactless IC card 26.

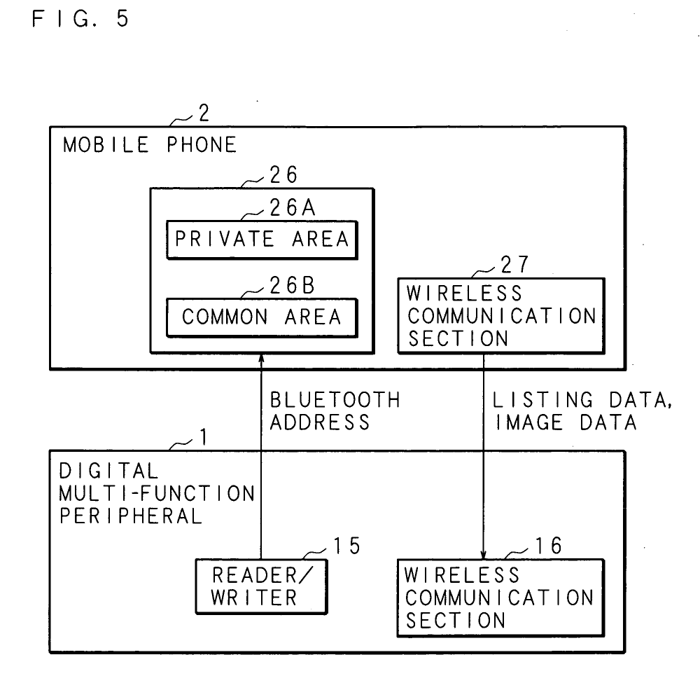

FIG. 5 is a diagram illustrating a configuration of the storage area of the contact/contactless IC card 26 according to Embodiment 1. In the storage area of the contact/contactless IC card 26, there are a private area 26A (free area) and a common area 26B. The digital multi-function peripheral address (identification data) which the contact/contactless IC card 26 has received is written in the private area 26A. The private area 26A is an area where a service provider can use freely. A high degree of freedom in writing can be obtained by using the private area 26A. On the other hand, the CPU of the mobile phone 2 can also write data in the common area 26B. However, in this case, the service provider must use a remote issue system for a network which the contact/contactless IC card 26 has. For this reason, the common area 26B has a problem that the degree of freedom in writing is low.

The CPU of the mobile phone 2 requests pairing from the digital multi-function peripheral 1, and transmits a Bluetooth address (hereinafter, referred to as a “mobile phone address”) of the wireless communication section 27 (Step S203). More specifically, the wireless communication section 27 of the mobile phone 2 transmits the mobile phone address and the data for requesting the pairing to the wireless communication section 16 of the digital multi-function peripheral 1.

By monitoring the wireless communication section 16, the CPU of the digital multi-function peripheral 1 determines whether the wireless communication section 16 has received the pairing request and the mobile phone address from the mobile phone 2 (Step S103). If it determines that the wireless communication section 16 has not received the pairing request and the mobile phone address (Step S103: NO), the CPU of the digital multi-function peripheral 1 stands by until the wireless communication section 16 receives the pairing request and the mobile phone address from the mobile phone 2. On the other hand, if it determines that wireless communication section 16 has received the pairing request and the mobile phone address (Step S103: YES), the CPU of the digital multi-function peripheral 1 stores the mobile phone address which the wireless communication section 16 has received in the storage section 14. Then, the CPU of the digital multi-function peripheral 1 displays a passkey entry screen which prompts the user to enter a passkey on the display section 13 of the operation panel 12 (Step S104). The CPU of the digital-multi-function peripheral 1 thus requests entry from the user.

The user then operates the operation panel 12 or the display section 13 (if it is a touch panel) to enter the passkey. The CPU of the digital multi-function peripheral 1 accepts the passkey which the user has entered via the operation panel 12 or the display section 13 (if it is a touch panel) (Step S105). The CPU of the digital multi-function peripheral 1 stores the passkey temporarily in the storage section 14.

The CPU of the digital multi-function peripheral 1 compares the passkey entered by the user with a passkey stored in advance in the storage section 14. If the CPU of the digital multi-function peripheral 1 determines that the entered passkey is correct, the pairing is completed, and the digital multi-function peripheral 1 and the mobile phone 2 are connected with each other. The digital multi-function peripheral 1 and the mobile phone 2 are set to a state in which they can communicate with each other. On the other hand, if the CPU of the digital multi-function peripheral 1 determines that the entered passkey is not correct, it notifies this and the CPU of the digital multi-function peripheral 1 displays a screen which prompts the user for an entry by the user again on the display section 13.

Then, the CPU of the digital multi-function peripheral 1 transmits instruction data for instructing execution of the application program via the wireless communication section 16 to the mobile phone 2 (Step S106).

The CPU of the mobile phone 2 receives the instruction data for instructing execution of the application program from the digital multi-function peripheral 1 via the wireless communication section 27 (Step S204).

The CPU of the mobile phone 2 executes the first application program P1 which is selected by the user at Step S201 and is accepted by the CPU of the mobile phone 2. More specifically, the CPU of the mobile phone 2 receives the instruction data for instructing execution of the application program. The CPU of the mobile phone 2 then reads out the listing data stored in the flash memory 24, and transmits the listing data to the wireless communication section 16 of the digital multi-function peripheral 1 via the wireless communication section 27 (Step S205).

The CPU of the digital multi-function peripheral 1 receives via the wireless communication section 16 the listing data transmitted from the mobile phone 2 (Step S107). The CPU of the digital multi-function peripheral 1 then stores the listing data in the storage section 14.

The CPU of the digital multi-function peripheral 1 displays a list screen on the display section 13 based on the listing data stored in the storage section 14 (Step S108). The list screen is a screen from which a selection of a file which the user wants to print out is accepted from the user.

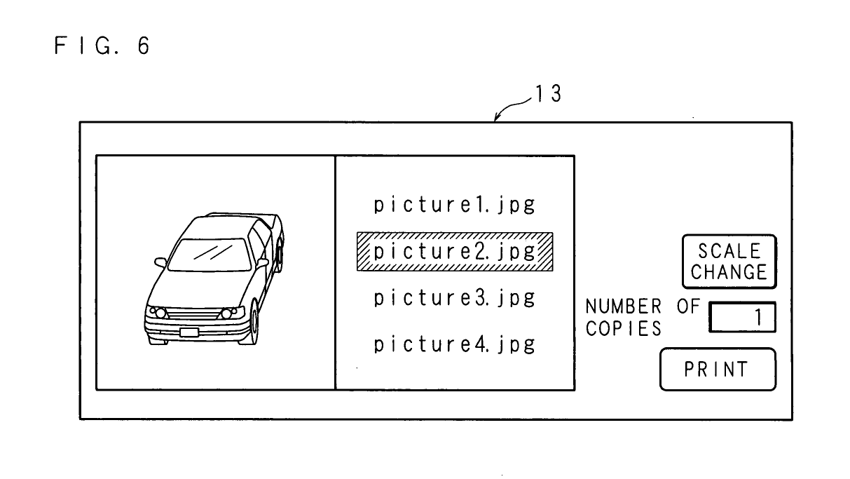

FIG. 6 is an illustrated view showing an example of the list screen displayed on the display section 13 of the digital multi-function peripheral 1 according to Embodiment 1. In the list screen, a plurality of file names are displayed based on the listing data on a screen which can be scrolled, for example. When the user selects a file by operating the operation panel 12 or the display section 13 (if it is a touch panel), thumbnails of the file are displayed on the list screen. In the list screen, soft keys representing “scale change,” “number of copies,” and “print,” etc., are provided. By these keys, the digital multi-function peripheral 1 can accept printing conditions, such as the number of copies to be printed and a scale change factor from the user. After the user selects a file which he/she wants to print out and inputs printing conditions, he/she operates the “print” soft key. By this operation, the user instructs the digital multi-function peripheral 1 to start printing. Thus, by the user operating the operation panel 12 or the display section 13 (if it is a touch panel) in the digital multi-function peripheral 1, it becomes unnecessary for the user to operate small keys of the mobile phone 2 while looking at the small LCD monitor screen of the mobile phone 2. Because the user operates the large operation panel 12 or the large display section 13 of the digital multi-function peripheral 1, operability of the keys and referencability of the image will be higher.

The CPU of the digital multi-function peripheral 1 accepts from the user selection of a file which the user wants to print out, via the operation panel 12 or the display section 13 (if it is a touch panel) (Step S109). If the selection of a file is accepted from the user, the CPU of the digital multi-function peripheral 1 determines whether it has accepted print instruction from the user (Step S110). This determination is performed by the CPU of the digital multi-function peripheral 1 monitoring the operation panel 12 and the display section 13 (if it is a touch panel).

If the CPU of the digital multi-function peripheral 1 determines that it has not accepted the print instruction from the user (Step S110: NO), it stands by until it receives the print instruction from the user. On the other hand, if the CPU of the digital multi-function peripheral 1 determines that it has accepted the print instruction from the user (Step S110: YES), it transmits request data for requesting the mobile phone 2 for the image data of the selected file (hereinafter, referred to as the “selected file”), to the mobile phone 2 via the wireless communication section 16 (Step S111).

The CPU of the mobile phone 2 receives the request data for requesting the image data of the selected file from the digital multi-function peripheral 1 via the wireless communication section 27 (Step S206). The CPU of the mobile phone 2 then receives the request data, and reads out the image data of the selected file from the flash memory 24. The CPU of the mobile phone 2 then transmits the image data of the selected file to the digital multi-function peripheral 1 via the wireless communication section 27 (Step S207).

The CPU of the digital multi-function peripheral 1 receives the image data of the selected file from the mobile phone 2 via the wireless communication section 16 (Step S112). The CPU of the digital multi-function peripheral 1 then stores the image data in the storage section 14.

The CPU of the digital multi-function peripheral 1 transmits the image data stored in the storage section 14 to the image output section 19. The CPU of the digital multi-function peripheral 1 instructs the image output section 19 to print out the image based on the image data, and prints out the image on a sheet (Step S113).

The CPU of the digital multi-function peripheral 1 transmits data that notifies the printed results to the mobile phone 2 via the wireless communication section 16 (Step S114). The printed results include normal completion of printing, occurrence of abnormality during printing, etc. At Step S114, the CPU of the digital multi-function peripheral 1 terminates the processing.

The CPU of the mobile phone 2 obtains the data that notifies the printed results via the wireless communication section 27 from the digital multi-function peripheral 1 (Step S208). The CPU of the mobile phone 2 stores the data in the flash memory 24.

The CPU of the mobile phone 2 outputs the printed results to the display section 22 based on the data stored in the flash memory 24 (Step S209). At Step S209, the CPU of the mobile phone 2 terminates the processing. Here, as a method that the CPU of the mobile phone 2 outputs the printed results, there is a method of displaying the printed results on the LCD monitor of the mobile phone 2 in text data. Alternatively, the CPU of the mobile phone 2 may not output the printed results to the display section 22 but outputs a sound or an alarm from a speaker of the mobile phone 2 to notify the printed results.

As described above, in the information processing system and the image forming system according to Embodiment 1, the mobile phone 2 receives the digital multi-function peripheral address from the digital multi-function peripheral 1, and the user then transmits data from the mobile phone 2 using the digital multi-function peripheral address. Thereby, it is prevented in advance that the secret information (the address, the passkey, etc.) of the mobile phone 2 leaks against the user's intention.

In the description of Embodiment 1, the user manually enters the passkey in order to set the passkey certainly. However, if priority is given to a user's convenience, the reader/writer 15 of the digital multi-function peripheral 1 and the contact/contactless IC card 26 of the mobile phone 2 may deliver the passkey from one to the other.

Note that, if the information processing system and the image forming system according to the present invention are configured with devices to which a passkey cannot be entered (a mouse, a headset, etc.), the passkey may be a fixed value, or the entry operation of the passkey may be omitted. Further, if the device to which a passkey cannot be entered is used, the passkey may be a passkey of simple enumeration, such as “0000,” as its default value.

### Embodiment 2

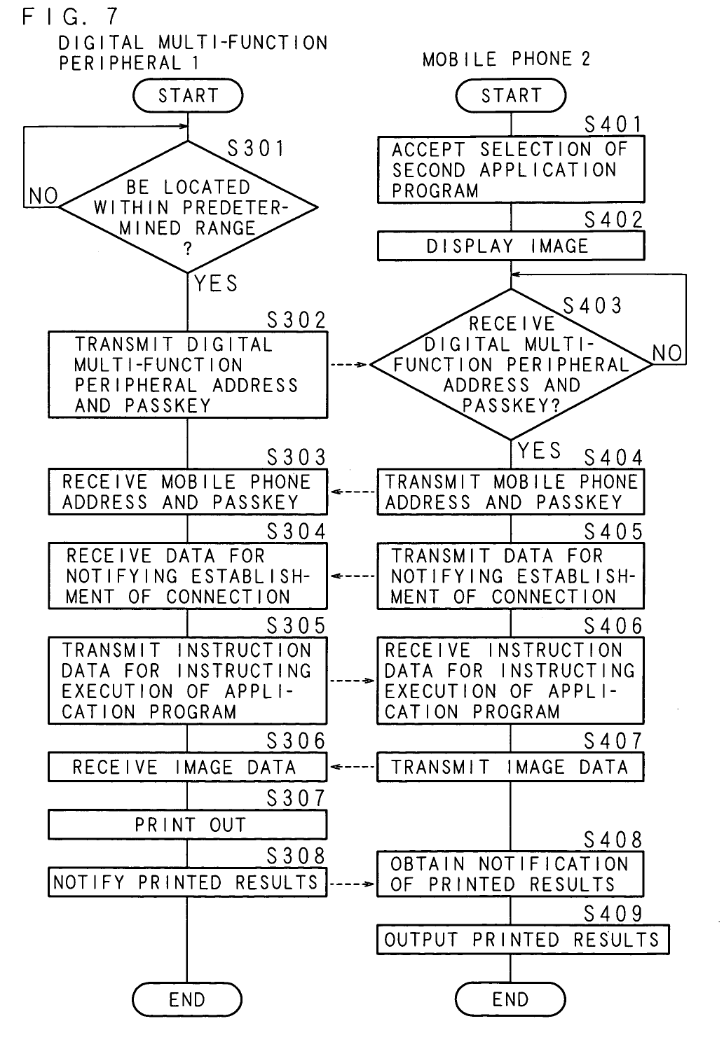

Hereinbelow, an Information Processing System, an information processing device and a communication device, and an image forming system and an image forming device according to Embodiment 2 are described. As examples of processing which they perform, processing which the digital multi-function peripheral 1 and the mobile phone 2 perform (information processing, image formation) are described. As an example of the processing which the digital multi-function peripheral 1 and the mobile phone 2 perform (information processing, image formation), Embodiment 2 is described about the case where the mobile phone 2 transmits image data stored in the mobile phone 2 to the digital multi-function peripheral 1, and the digital multi-function peripheral 1 prints out the image on a sheet. In the information processing system and the image forming system according to Embodiment 2, the reader/writer 15 of the digital multi-function peripheral 1 and the contact/contactless IC card 26 of the mobile phone 2 deliver a passkey from one to the other. FIG. 7 is a flowchart showing procedures executed by the CPU of the control section 11 of the digital multi-function peripheral 1 and the CPU of the control section 21 of the mobile phone 2, according to Embodiment 2.

Similar to Embodiment 1, before the user transmits the image data to the digital multi-function peripheral 1, he/she operates the operation panel 28 of the mobile phone 2 to select an application program associated with the image data. Hereinafter, the case where the user selects the second application program P2 is described for the sake of convenience of explanation.

Similar to Embodiment 1, the user operates the operation panel 28 to select the second application program P2, and the CPU of the mobile phone 2 accepts the selection of the second application program P2 via the operation panel 28 (Step S401).

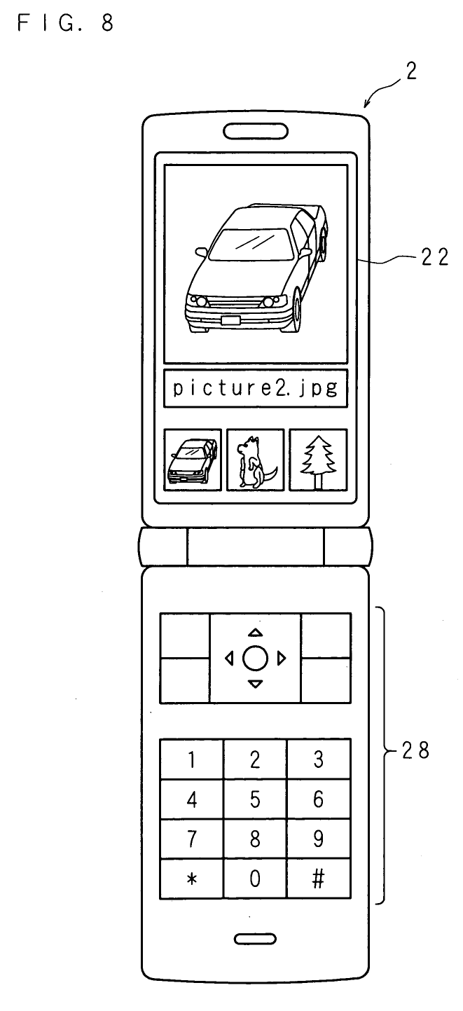

The user selects an image to be printed out by operating the mobile phone 2. The mobile phone 2 displays the image on the display section 22 (Step S402). FIG. 8 is a diagram illustrating an operation for selecting the image which the user intends to print out, and an operation for displaying the image which the user has selected on the display section 22, in the mobile phone 2 according to Embodiment 2. On the display section 22 of the mobile phone 2, thumbnails of the image data stored in the flash memory 24 are displayed. The user operates the operation panel 28 (a push button, etc.) to move a cursor. Thereby, the user can select one of the thumbnails. When the user selects one of the thumbnails, the name of a file associated with the selected thumbnail (hereinafter, a selected file) and an enlarged thumbnail are displayed on the display section 22. After selecting the file which the user wants to print out, he/she holds the mobile phone 2 over the reader/writer 15 of the digital multi-function peripheral 1.

The CPU of the digital multi-function peripheral 1 determines whether the mobile phone 2 is located within a predetermined range (Step S301). The determination method is the same as the method described in Embodiment 1. If the CPU of the digital multi-function peripheral 1 determines that the mobile phone 2 is not located within the predetermined range (Step S301: NO), it stands by until the mobile phone 2 is located within the predetermined range. On the other hand, if the CPU of the digital multi-function peripheral 1 determines that the mobile phone 2 is located within the predetermined range (Step S301: YES), it reads out a Bluetooth address (hereinafter, referred to as a “digital multi-function peripheral address”) and a passkey which the wireless communication section 16 has, and transmits the digital multi-function peripheral address and the passkey to the reader/writer 15. The reader/writer 15 transmits the digital multi-function peripheral address and the passkey to the contact/contactless IC card 26 of the mobile phone 2 (Step S302).

The CPU of the mobile phone 2 determines by monitoring the contact/contactless IC card 26 whether the contact/contactless IC card 26 has received the digital multi-function peripheral address and the passkey (Step S403). If the CPU of the mobile phone 2 determines that the contact/contactless IC card 26 has not received the digital multi-function peripheral address and the passkey (Step S403: NO), it stands by until the contact/contactless IC card 26 receives the digital multi-function peripheral address and the passkey. On the other hand, if the CPU of the mobile phone 2 determines that contact/contactless IC card 26 has received the digital multi-function peripheral address and the passkey (Step S403: YES), it stores the digital multi-function peripheral address and the passkey, which the contact/contactless IC card 26 has received, in a storage area of the contact/contactless IC card 26.

The CPU of the mobile phone 2 transmits a Bluetooth address (hereinafter, referred to as a “mobile phone address”) and the passkey of the wireless communication section 27 which are stored in the flash memory 24 to the digital multi-function peripheral 1 via the wireless communication section 27 (Step S404). The mobile phone 2 is connected with the digital multi-function peripheral 1 at Step S404.

The CPU of the digital multi-function peripheral 1 receives the mobile phone address and the passkey from the mobile phone 2 via the wireless communication section 16 (Step S303). The CPU of the digital multi-function peripheral 1 stores the mobile phone address and the passkey in the storage section 14. By the digital multi-function peripheral 1 receiving the mobile phone address and the passkey from the mobile phone 2, pairing of the digital multi-function peripheral 1 and the mobile phone 2 is completed. The digital multi-function peripheral 1 and the mobile phone 2 are connected with each other, and the digital multi-function peripheral 1 and the mobile phone 2 are set into a state in which communication is possible between them.

The CPU of the mobile phone 2 transmits data, which notifies that it is connected with the digital multi-function peripheral 1, to the digital multi-function peripheral 1 via the wireless communication section 27 (Step S405). Thereby, the CPU of the mobile phone 2 notifies to the digital multi-function peripheral 1 that the mobile phone 2 is connected with the digital multi-function peripheral 1.

The CPU of the digital multi-function peripheral 1 then receives the data, which notifies that the digital multi-function peripheral 1 is connected with the mobile phone 2, from the mobile phone 2 via the wireless communication section 16 (Step S304). The CPU of the digital multi-function peripheral 1 then transmits instruction data for instructing execution of an application program to the mobile phone 2 via the wireless communication section 16 (Step S305).

The CPU of the mobile phone 2 receives the instruction data for instructing execution of the application program from the digital multi-function peripheral 1 via the wireless communication section 27 (Step S406).

The CPU of the mobile phone 2 executes the second application program P2 selected by the user at Step S401 and accepted by the CPU of the mobile phone 2. More specifically, the CPU of the mobile phone 2 receives the instruction data for instructing execution of the application program. The CPU of the mobile phone 2 reads out from the flash memory 24 the image data of the image displayed on the display section 22 when the mobile phone 2 receives the instruction data. The image described herein is an image displayed on the display section 22 at Step S402. The CPU of the mobile phone 2 then transmits the image data to the wireless communication section 16 of the digital multi-function peripheral 1 via the wireless communication section 27 (Step S407).

The CPU of the digital multi-function peripheral 1 receives the image data from the mobile phone 2 via the wireless communication section 16 (Step S306). The CPU of the digital multi-function peripheral 1 then stores the image data in the storage section 14.

The CPU of the digital multi-function peripheral 1 transmits the image data stored in the storage section 14 to the image output section 19. The CPU of the digital multi-function peripheral 1 then instructs the image output section 19 to print out the image based on the image data, and then prints out the image on a sheet (Step S307).

The CPU of the digital multi-function peripheral 1 then transmits data, which notifies the printed results, to the mobile phone 2 via the wireless communication section 16 (Step S308). The printed results include normal completion of printing, occurrence of abnormality during printing, etc. At Step S308, the CPU of the digital multi-function peripheral 1 terminates the processing.

The CPU of the mobile phone 2 obtains the data, which notifies the printed results, from the digital multi-function peripheral 1 via the wireless communication section 27 (Step S408). The CPU of the mobile phone 2 then stores the data in the flash memory 24.

The CPU of the mobile phone 2 then outputs the printed results to the display section 22 based on the data stored in the flash memory 24 (Step S409). At Step S409, the CPU of the mobile phone 2 terminates the processing.

As described above, in the information processing system and the image forming system according to Embodiment 2, the user selects the file of an image to be printed out by operating the mobile phone 2, and then brings the mobile phone 2 close to the digital multi-function peripheral 1. Thereby, the user can print out the image immediately, and the print job will be very easy.

In the description of Embodiment 2, like reference numerals are assigned to like components with respect to Embodiment 1 and, thus, the detailed descriptions about the components are omitted.

In the description of Embodiment 1 or 2, the digital multi-function peripheral 1 has two application programs associated with transmission of the data. However, the number of application programs is not limited to two. Many application programs may be provided to meet the user's needs to improve the user friendliness. Alternatively, one of the application programs may be executed synchronously with another other application program. For example, if the second application program P2 is selected at the digital multi-function peripheral 1 for rent installed in a convenience store, every time image data is transmitted from the mobile phone 2, an application program associated with billing of electronic money may be executed synchronously with the transmission.

In Embodiment 1 or 2, the information processing system, the information processing device, the communication device, the image forming system, and the image forming device according to the present invention are described using the digital multi-function peripheral 1 and the mobile phone 2. However, the devices that constitute the information processing system, the information processing device, the communication device, the image forming system, and the image forming device according to the present invention may not be limited to the digital multi-function peripheral 1 and the mobile phone 2. For example, the mobile phone 2 may be a digital camera that has a communication function. The mobile phone 2 may be also a personal digital assistant which is called a “mobile computer” or a “PDA (Personal Digital Assistance).” Further, the digital multi-function peripheral 1 may transmit to the mobile phone 2 data of a document image scanned by a scanner which the digital multi-function peripheral 1 has, as well as the mobile phone 2 transmits data to the digital multi-function peripheral 1. Alternatively, the digital multi-function peripheral 1 may transmit to the mobile phone 2 data of facsimile images, electronic data and the like accumulated in the memory storage of the digital multi-function peripheral 1. Further, even if the information processing system, the information processing device, the communication device, the image forming system, and the image forming device according to the present invention are constituted with devices that includes two or more communication sections and can communicate with each other, similar effects described in Embodiment 1 or 2 can also be attained. The devices that includes two or more communication sections and can communicate with each other may include the digital multi-function peripheral 1 having the reader/writer 15 and the wireless communication section 16, or the mobile phone 2 having the contact/contactless IC card 26 and the wireless communication section 27, for example.

In Embodiment 1 or 2, the user holds the mobile phone 2 over the reader/writer 15 of the digital multi-function peripheral 1, and the digital multi-function peripheral address is transmitted to the contact/contactless IC card 26 of the mobile phone 2 from the reader/writer 15. However, the transmission method is not limited to this. For example, when the user holds the mobile phone 2 over the reader/writer 15 of the digital multi-function peripheral 1, the mobile phone address may be transmitted to the reader/writer 15 from the contact/contactless IC card 26 of the mobile phone 2. Alternatively, instruction data for instructing execution of an application program may be transmitted instead of the address.

In Embodiment 1 or 2, the digital multi-function peripheral 1 receives image data from the mobile phone 2 and prints out an image based on the image data. However, processing of the digital multi-function peripheral 1 is not limited to printing of an image (image formation) based on image data. Even if the digital multi-function peripheral 1 processes the data, the information processing system, the information processing device, the communication device, the image forming system, and the image forming device according to the present invention can obtain similar effects to those of the present invention described in Embodiment 1 or 2. The data processing is processing, such as editing of text data, changing a scale of an image, or rotating of the image data, performed when the digital multi-function peripheral 1 receives text data, image data, or the like from a personal digital assistant called a “mobile computer” or “PDA.”

As this description may be embodied in several forms without departing from the spirit of essential characteristics thereof, the present embodiment is therefore illustrative and not restrictive, because the scope is defined by the appended claims rather than by the description preceding them and all changes that fall within metes and bounds of the claims, or equivalence of such metes and bounds thereof are therefore intended to be embraced by the claims.

What is claimed is:

1. An information processing system, comprising:
a communication device; and
an information processing device for obtaining data from the communication device and processing the data;
wherein the communication device includes:
a first transmission and reception section for performing transmission and reception of data to and from the information processing device;
a reception section for receiving identification data for identifying the information processing device from the information processing device; and
a storage section for storing an application program associated with the transmission and reception of data to and from the information processing device; and
the information processing device includes:
a second transmission and reception section for performing transmission and reception of data to and from the first transmission and reception section;
a transmission section for transmitting identification data for identifying the information processing device to the reception section of the communication device; and
an instruction transmission section for transmitting instruction data for instructing execution of the application program stored in the storage section to the first transmission and reception section.

2. The information processing system according to claim 1, wherein
the storage section stores a plurality of application programs,
the communication device further includes:
a selection accepting section for accepting a selection of an application program to be executed from the plurality of application programs; and
an execution section for executing the application program associated with the selection accepted by the selection accepting section when the instruction data is received.

3. The information processing system according to claim 1, wherein
the communication device further includes a display section for displaying images associated with the stored contents; and
the storage section stores a first application program including processing for transmitting listing data indicative of a listing of the stored contents to the information processing device, or a second application program including processing for transmitting data of the contents associated with the images displayed on the display section to the information processing device.

4. The information processing system according to claim 3, wherein
the communication device transmits data of the contents associated with images displayed on the display section to the second transmission and reception section of the information processing device, when the communication device is located within a predetermined distance from the information processing device in the case where the selection accepting section has accepted the selection of the first application program.

5. The information processing system according to claim 3, wherein
the information processing device further includes:
a display section for displaying a list screen based on the received listing data;
a content selection accepting section for accepting a selection of a content from the contents displayed on the display section; and
a request transmission section for transmitting request data for requesting data of the content accepted by the content selection accepting section to the communication device.

6. The information processing system according to claim 1, wherein
the transmission section and the reception section communicate by using a RFID (Radio Frequency IDentification) system, and the first transmission and reception section and the second transmission and reception section communicate by radio over a longer distance or at a higher speed than with the RFID system.

7. The information processing system according to claim 6, wherein
the communication device stores the identification data received by the reception section in a free area of a storage area within the RFID system.

8. An information processing device, comprising:
a transmission and reception section for performing transmission and reception of data to and from an external device;
a transmission section for transmitting identification data for identifying the transmission and reception section; and
an instruction transmission section for transmitting instruction data for instructing execution of an application program associated with transmission and reception of data and stored in a partner for transmission and reception.

9. The information processing device according to claim 8, further comprising:
a display section for displaying, when the transmission and reception section has received listing data indicative of listings of contents stored in the partner for transmission and reception, a list screen based on the listing data;
a content selection accepting section for accepting a selection of content from the contents displayed on the display section; and
a request transmission section for transmitting request data for requesting data of the content accepted by the content selection accepting section to the partner for transmission and reception.

10. A communication device, comprising:
a communication section for communicating;
a reception section for receiving identification data for identifying a partner for communication from the partner for communication;
a storage section for storing a plurality of application programs associated with communication with the partner for communication;
a selection accepting section for accepting a selection of the application program to be executed from the plurality of application programs; and
an execution section for executing the program associated with the selection accepted by the selection accepting section when predetermined data is received.

11. The communication device according to claim 10, comprising:
a display section for displaying images associated with contents stored;
wherein the storage section stores a first application program including processing for transmitting listing data for displaying the stored contents by listings, or a second application program including processing for transmitting data of the contents associated with the images displayed on the display section.

12. An image forming system comprising:
a portable communication device; and
an image forming device for obtaining data from the portable communication device and forming an image based on the data;
wherein the portable communication device includes:
a first transmission and reception section for performing transmission and reception of data to and from the image forming device;
a reception section for receiving identification data for identifying the image forming device from the image forming device; and
a storage section for storing an application program associated with transmission and reception of data to and from the image forming device; and
the image forming device includes:
a second transmission and reception section for performing transmission and reception of data to and from the first transmission and reception section;
a transmission section for transmitting identification data for identifying the image forming device to the reception section; and
an instruction transmission section for transmitting instruction data for instructing execution of the application program stored in the storage section.

13. The image forming system according to claim 12, wherein
the image forming device further includes:
a notifying section for notifying the portable communication device of an abnormality occurrence or a normal termination in formation of an image.

14. An image forming system, comprising:
a portable communication device; and
an image forming device for obtaining data from the portable communication device and forming an image based on the data;
wherein the portable communication device includes:
a first data communication section for performing communication of data with the image forming device by using a Bluetooth communication protocol;
a reception section for receiving a unique address of the image forming device from the image forming device by using a RFID communication protocol;
a storage section for storing a plurality of application programs associated with communication of the data with the image forming device; and
a selection accepting section for accepting a selection of an application program to be executed from the plurality of application programs; and
the image forming device includes:
a second data communication section for performing communication of data with the first data communication section by using the Bluetooth communication protocol;
a transmission section for transmitting the unique address of the image forming device to the reception section by using the RFID communication protocol; and
an instruction transmission section for transmitting instruction data for instructing execution of the application program stored in the storage section; and
the portable communication device executes the program associated with the selection accepted by the selection accepting section when the instruction data is received.

15. An image forming device, comprising:
a communication section for performing communication of data by using a Bluetooth communication protocol;
a transmission section for transmitting a unique address of the communication section by using a RFID communication protocol;
an instruction transmission section for transmitting instruction data for instructing execution of an application program associated with the communication of the data and stored in a partner for communication; and
a display section;
wherein an image based on the data received by execution of the application program is formed on the display section or a sheet.
